(19) United States
(12) Patent Application Publication
(10) Pub. No.: US 2023/0351152 A1
(43) Pub. Date: Nov. 2, 2023

(54) MUSIC ANALYSIS METHOD AND APPARATUS FOR CROSS-COMPARING MUSIC PROPERTIES USING ARTIFICIAL NEURAL NETWORK

(71) Applicant: Neutune Co.,Ltd., Seoul (KR)

(72) Inventors: Jong Pil LEE, Seoul (KR); Sangn Eun Kum, Seoul (KR); Tae Hyoung kim, Seoul (KR); Keun Hyoung Kim, Daejeon (KR)

(73) Assignee: Neutune Co.,Ltd., Seoul (KR)

(21) Appl. No.: 18/350,389

(22) Filed: Jul. 11, 2023

(30) Foreign Application Priority Data
Feb. 12, 2022 (KR) 10-2022-0167096
Jul. 12, 2022 (KR) 10-2022-0085464

(51) Int. Cl. G06N 3/04; G06N 3/08

(52) U.S. Cl. CPC G06N 3/04; G06N 3/08

(57) ABSTRACT

A music analysis device that cross-compares music properties using an artificial neural network comprises a processor including an artificial neural network module and a memory module storing instructions executable by the processor. The artificial neural network module includes a pre-processing module that outputs stem data that is specific attribute data constituting the audio data according to a preset standard for the input audio data, a first artificial neural network that takes first stem data as first input information and outputs a first embedding vector that is an embedding vector for the first stem data as first output information, a second artificial neural network that takes second stem data as second input information and outputs a second embedding vector that is an embedding vector for the second stem data as second output information and a dense layer that uses information the first output information and the second output information are used as input information and output a first tagging information and a second tagging information as output information which are music tagging information for the first output information and the second output information.

### CROSS-REFERENCE TO RELATED APPLICATIONS

This application is based on and claims priority to Korean Patent Application No. 10-2022-0085464, filed on Jul. 12, 2022 in the Korean Intellectual Property Office, and Korean Patent Application No. 10-2022-0167096, filed on Dec. 2, 2022, in the Korean Intellectual Property Office, the disclosures of which are incorporated herein by reference in their entireties.

### TECHNICAL FIELD

The present invention relates to a music analysis method and apparatus for cross-comparing music properties using an artificial neural network, and more particularly, it is an invention related to a method for cross-analyzing various properties of music and a method for cross-analyzing various properties of music based thereon to compare similar properties of music.

### BACKGROUND ART

Looking at the music search types proposed so far, there are five types (text query (query-by-text), humming query (query-by-humming), partial query (query-by-part), example query (query-by- example), class query (query-by-class)).

The text query search method is processed according to the query processing method of the existing information retrieval system based on the bibliographic information (author, song title, genre, etc.) stored in the music information database.

The humming query method refers to a method of recognizing humming as a query when a user input humming and finding songs having similar melodies.

In the partial query method, when a user likes a song while listening to music and wants to know if the song is currently stored in his or her terminal, but does not know the song name or melody, similar songs are found by inputting the music being played.

The example query method is a method of finding similar songs when a user selects a specific song. The example query method is similar with the partial query method, but the example query uses the entire song as an input, and the partial query uses only a part of the song as an input.

In addition, in the example query, the title of a song is used as input information instead of actual music, but in the partial query, actual music is used as input.

The class query method is a method in which music is classified according to genre or atmosphere in advance and then selected according to taxonomy.

Among the five search methods, humming query, partial query, and example query are not general search methods and can only be used in special situations. Therefore, the most common performed method is a text query or a class query. However, both methods require expert or operator intervention. That is, when new music is released, it is necessary to input necessary bibliographic information or to determine which category it belongs to according to taxonomy. In a situation where new music continues to pour out like these days, this method becomes even more problematic.

One of the solutions to this problem is to use a method of automatically tagging according to a taxonomy. It automatically classifies and automatically inputs bibliographic information corresponding to the classification or assigns a classification code. However, classification according to taxonomy is a method of direct classification by some specific class that manages a site, such as a librarian or operator, and requires knowledge of a specific system. Therefore, there is a problem that expansion may be lacking when a new item is added.

### PRIOR ART DOCUMENT

(PATENT DOCUMENT 1) Korean Patent Publication No. 10-2015-0084133 (published on 2015.07.22) - ‘pitch recognition using sound interference and a method for transcribing scales using the same’
(PATENT DOCUMENT 2) Korean Patent Registration No. 10-1696555 (2019.06.05.) - ‘System and method for searching text position through voice recognition in video or geographic information’

### DISCLOSURE

### Technical Problem

Therefore, a music analysis method and apparatus for cross-comparing music properties using an artificial neural network according to an embodiment is an invention designed to solve the above-described problems, and easily analyzes the characteristics of music using an artificial neural network module. And an object of the present invention is to provide a method and apparatus capable of more accurately searching for similar music based on the analyzed result.

More specifically, a music analysis method and apparatus for cross-comparing music properties using an artificial neural network according to an embodiment converts data in which sound sources are classified by property and data of the sound source itself into an embedding vector, respectively, The purpose is to provide a technology that more accurately extracts information on sound sources and properties by comparing and analyzing each other using artificial neural networks in a common space.

Furthermore, an object of the present invention is to provide a technology for searching for a sound source most similar with the properties of a sound source/music input by a user using a learned artificial neural network.

### Technical Solution

### [Advantageous Effects]

According to an embodiment, a music analysis method and apparatus for cross-comparing music properties using an artificial neural network combine an embedding vector for a sound source itself and an embedding vector generated based on data obtained by separating music properties from a sound source into one space. After cross-comparison analysis is performed, the embedding vector for the audio data corresponding to the sound source and the embedding vector generated based on the data obtained by separating only specific attributes from the entire audio data are compared and analyzed in one space. Therefore, since various characteristics of the embedding vector can be reflected, there is an advantage in that tagging information that more accurately reflects the characteristics of music can be output.

Accordingly, the music analysis method and apparatus according to the present invention can provide various services such as a singer identification service and a similar music service based on the generated embedding vector and tagging information, and there exists the advantage that also increasing the accuracy of the service.

### BRIEF DESCRIPTION OF DRAWINGS

FIG. 1 is a block diagram illustrating some components of a music analysis device according to an embodiment of the present invention.

FIG. 2 is a diagram showing the configuration of a processor and input and output information according to an embodiment of the present invention.

FIG. 3 is a diagram showing the configuration of a processor and input and output information according to another embodiment of the present invention.

FIG. 4 is a diagram for explaining how various types of embedding vectors according to the present invention are compared and analyzed in one embedding space.

FIG. 5 is a diagram for explaining how an artificial neural network module learns according to an embodiment of the present invention.

FIG. 6 is a diagram illustrating a learning method using an embedding vector according to the prior art.

FIG. 7 is a diagram illustrating a learning method using an embedding vector according to the present invention.

FIG. 8 is a diagram for explaining a learning step and an inference step of a music analysis device according to the present invention. The top diagram explains the learning step of an artificial neural network module, and The bottom diagram explains the inference step of the artificial neural network module.

FIG. 9 is a diagram illustrating a result of measuring similarity based on tagging information output by an artificial neural network module according to the present invention.

FIG. 10 is a diagram illustrating various embodiments of a music search service according to an embodiment of the present invention.

### MODES OF THE INVENTION

Hereinafter, embodiments according to the present invention will be described with reference to the accompanying drawings. In adding reference numbers to each drawing, it should be noted that the same components have the same numerals as much as possible even if they are displayed on different drawings. In addition, in describing an embodiment of the present invention, if it is determined that a detailed description of a related known configuration or function hinders understanding of the embodiment of the present invention, the detailed description thereof will be omitted. In addition, embodiments of the present invention will be described below, but the technical idea of the present invention is not limited or limited thereto and can be modified and implemented in various ways by those skilled in the art.

In addition, terms used in this specification are used to describe embodiments and are not intended to limit and/or limit the disclosed invention. Singular expressions include plural expressions unless the context clearly dictates otherwise.

In this specification, terms such as “include”, “include” or “have” are intended to designate that there is a feature, number, step, operation, component, part, or combination thereof described in the specification, but one or the existence or addition of more other features, numbers, steps, operations, components, parts, or combinations thereof is not excluded in advance.

In addition, throughout the specification, when a part is said to be “connected” to another part, this is not only the case where it is “directly connected”, but also the case where it is “indirectly connected” with another element in the middle. Terms including ordinal numbers, such as “first” and “second” used herein, may be used to describe various components, but the components are not limited by the terms.

Hereinafter, with reference to the accompanying drawings, embodiments of the present invention will be described in detail so that those skilled in the art can easily carry out the present invention. And to clearly explain the present invention in the drawings, parts irrelevant to the description are omitted.

Meanwhile, the title of the present invention has been described as ‘a music analysis method and apparatus for cross-comparing music properties using an artificial neural network’, but for convenience of explanation, ‘a music analysis method and apparatus for cross-comparing music properties using an artificial neural network’ will be abbreviated to ‘music analysis device’.

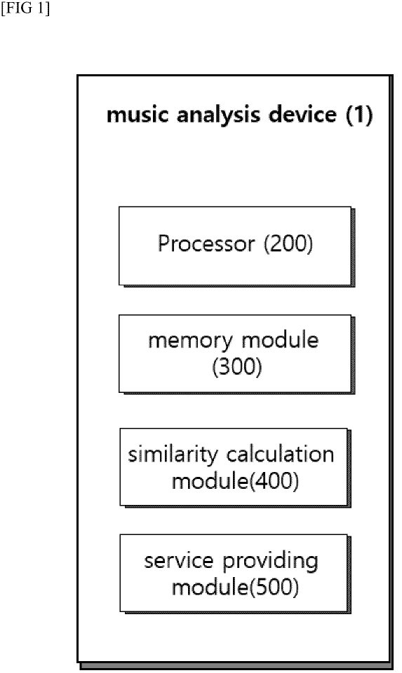

FIG. 1 is a block diagram illustrating some components of a music analysis device according to an embodiment of the present invention.

Referring to FIG. 1, a music analysis device 1 according to an embodiment may include a processor 200, a memory module 300, a similarity calculation module 400, and a service providing module 500.

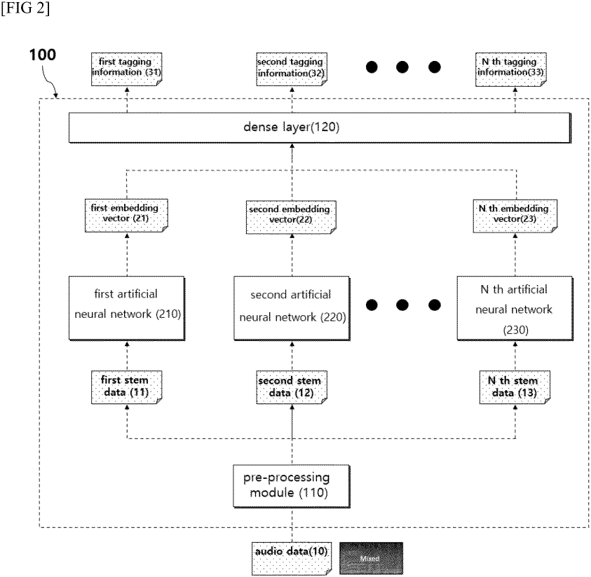

As will be described later, the processor 200 may include an artificial neural network module (100, see FIG. 2) including a plurality of artificial neural networks. The processor 200 calculates a feature vector for input audio data or stem data, outputs an embedding vector based on the calculated feature vector as intermediate output information, and outputs tagging information corresponding to the input data as final output information. And the output information may be transmitted to the memory module 300. A detailed structure and process of the artificial neural network module 100 will be described later in FIG. 2.

The memory module 300 may store various types of data necessary for implementing the music analysis device 1. For example, The memory module 300 may store audio data input to the music analysis device 1 as input information, stem data from which only data on a specific attribute of music is extracted from the audio data, and an embedding vector generated by the processor 200.

The audio data meant here means music data that includes all songs and accompaniments that we generally listen to. The audio data may be all or partially extracted data of the sound source.

Stem data refers to data separated from audio data for a specific property for a certain period. Specifically, a sound source constituting audio data is composed of a single result by combining human vocals and sounds of various musical instruments, and stem data refers to data for a single attribute constituting the sound source. For example, the type of stem may include vocal, bass, piano, accompaniment, beat, melody, and the like.

The stem data may be data having the same time as the audio data or may be data having only a part of the entire time of the sound source. In addition, the stem data may be divided into several parts according to the vocal range or function thereof.

Tagging information refers to information tagging characteristics of music, and tagging may include music genre (mood), instrument, and music creation time information.

Specifically, rock, alternative rock, hard rock, hip-hop, soul, classic, and jazz, punk, pop, dance, progressive rock, electronic, indie, blues, country, metal, indie rock, indie pop, folk, acoustic, ambient, R&B, heavy metal, electronica, funk, house House) and the like can be included as genres of music.

Music moods include sad, happy, mellow, chill, easy listening, catchy, sexy, and relaxing, chillout, beautiful, party, and etc.

Musical instruments may include a guitar, a male vocalist, a female vocalist, instrumental music, and the like.

The music creation time information is information about which years the music was created, and may correspond to, for example, the 1960s, 1970s, 1980s, 1990s, 2000s, 2010s, and 2020s.

The data stored in the memory module 300 may not simply be stored as a file but may be converted into information including an embedding vector generated by the artificial neural network modules of the processor 200 and stored.

Since the embedding vector includes a feature vector, each embedding vector expresses a feature of music data or property data in a vector format, and tagging information may be expressed as information about a specific property of music.

Therefore, in the present invention, various services such as finding a specific song or classifying similar songs can be performed by determining similarity between the two based on the embedding vector or tagging information. A method for determining mutual similarity will be described in the similarity calculation module 400, and various services will be described in detail in the service providing module 500.

Meanwhile, in the memory module 300, embedding vector information is not simply sporadically stored, but information on embedding vectors may be grouped according to a certain criterion. For example, embedding vectors for the same mantissa may be grouped, and embedding vectors may be grouped for each stem.

Accordingly, the memory module 300 includes a cache, a read only memory (ROM), a programmable ROM (PROM), an erasable programmable ROM (EPROM), an electrically erasable programmable ROM (EEPROM), and a flash memory ( It may be implemented as a non-volatile memory device such as flash memory, a volatile memory device such as RAM (Random Access Memory), or a collection of storage media such as a hard disk drive (HDD) and a CD-ROM.

Meanwhile, in FIG. 1, the memory module 300, the processor 200, and the similarity calculation module 400 are described as separate components, but the embodiment of the present invention is not limited thereto, and the processor 200 may simultaneously perform a role of memory module 300 and similarity calculation module 400.

The similarity calculation module 400 may determine the mutual similarity of the data in the form of an embedding vector stored in the memory module 300. That is, it is possible to determine whether the embedding vectors are similar with each other using a Euclidean distance such as Equation (1) below.

$$d \left(x , y\right) = \sqrt{{\left({x}_{1} - {x}_{2}\right)}^{2} + {\left({y}_{1} - {y}_{2}\right)}^{2}} \qquad \text{Equation (1):}$$

For example, if one of the embedding vectors that are the comparison standard is x and the other is y, the calculation is performed using the above formula, and if the value is high, it is judged that x and y are relatively similar in proportion. And if the calculation performance value is small, it can be determined that x and y have relatively strong dissimilarities. Accordingly, the mutual similarity of the data can be effectively determined based on these values.

The service providing module 500 may provide various services based on the results obtained by the similarity calculation module 400.

Specifically, the service providing module 500 can compare, classify, and analyze various music data and specific attribute data stored in the memory module 300 to provide various services that meet user needs.

For example, the service providing module 500 may provide a singer identification service, a similar music search service, a similar music search service based on a specific attribute, a vocal tagging service, a melody extraction service, a humming-query service, and the like. In the case of a search service, similar sound sources can be searched for based on sound source, similar sound sources can be searched based on stem, similar stems can be searched based on sound source, and similar stems can be searched based on stem. A detailed description of this will be described later.

So far, the components of the music analysis device 1 according to the present invention have been studied. Hereinafter, the configuration and effects of the processor 200 according to the present invention will be described in detail.

FIG. 2 is a diagram showing the configuration of an artificial neural network module and input information and output information according to an embodiment of the present invention.

Referring to FIG. 2, the artificial neural network module 100 may include a preprocessing module 110, a first artificial neural network 210, a second artificial neural network 220, and a dense layer 120. For convenience of description below, the artificial neural network module 100 is illustrated as including two artificial neural networks 210 and 220, but the artificial neural network module 200 is dependent on the number of stems input to the artificial neural network module 200. Correspondingly, more than two, n artificial neural networks may be included.

The pre-processing module 110 may analyze the input audio data 10 and output stem data. Audio data, which is meant in the present invention, means a sound source in which vocals and accompaniments are mixed, which we generally talk about. Audio data may be referred to as mix data depending on the nature of mixing vocals and various accompaniments.

As described above, since a stem may be composed of several attributes, the preprocessing module 110 may output a plurality of stem data. For example, drum stem data from which only drum attributes are separated, vocal stem data from which only vocal attributes are separated, piano stem data from which only piano attributes are separated, accompaniment stem data from which only accompaniments are separated, etc. may be output. In addition, the stem data output in this way may be input as input information to a corresponding artificial neural network in advance. That is, drum stem data may be input to an artificial neural network that analyzes drum stem data, and vocal stem data may be input to an artificial neural network that analyzes vocal stem data.

Hereinafter, for convenience of description, stem data output from the preprocessing module 110 is based on two pieces of drum stem data and vocal stem data. In addition, it is explained on the premise that the drum stem data is referred to as first stem data 11 and input to the first artificial neural network 210, and the vocal stem data is referred to as second stem data 12 and input to the second artificial neural network 220.

However, the embodiment of the present invention is not limited thereto, and the artificial neural network module 100 may have an artificial neural network corresponding to the number of stem types output by the preprocessing module 110. That is, when the preprocessing module 110 outputs 3 different types of stem data, the artificial neural network module 100 may include 3 artificial neural networks having different characteristics. In addition, when the preprocessing module 110 outputs 5 different types of stem data, the artificial neural network module 100 may include 5 artificial neural networks having different characteristics.

The first artificial neural network 210 according to the present invention which is a pre-learned artificial neural network receives the first stem data 11 output from the preprocessing module 110 as input information, and outputs the first embedding vector 21 that is an embedding vector for the first stem data 11 as output information.

The second artificial neural network 220 which is a pre-learned artificial neural network receives the second stem data 12 output from the preprocessing module 110 as input information and outputs a second embedding vector 22 that is an embedding vector for the second stem data 12 as output information.

The first artificial neural network 210 and the second artificial neural network 220 according to the present invention can be used by various types of well-known artificial neural network networks. Representatively, a convolutional neural network (CNN) based encoder structure can be used.

Specifically, the CNN model according to the present invention is composed of 7 convolutional layers with 128 3×3 filters, and each layer sequentially from the first layer is 64, 64, 128, 128, 256 It can contain 256 or 128 filters. Batch normalization, ReLU, and 2×2 max pooling layers may be applied after each convolution layer, and a global average pooling (GAP) layer may be applied as a pooling layer of the last convolution layer.

In addition, the network can output a Mel spectrogram with 128 Mel bins in each audio clip after applying a short-time Fourier transform using 1,024 window samples and samples of 512 hop sizes. In addition, the size of input data input to the encoder of the CNN network is 431 frames, corresponding to a 10-second segment at a sampling rate of 22,050 Hz.

On the other hand, in performing learning, the first artificial neural network 210 and the second artificial neural network 220 according to the present invention perform learning based on the output information output from each artificial neural network and the corresponding reference data, or each learning may be performed based on tagging information corresponding to output information output from the artificial neural network of and reference data corresponding to the tagging information. Furthermore, learning may be performed based on a plurality of tagging information associated with different artificial neural networks instead of one tagging information. A detailed description of this will be described later.

The dense layer 120 is a layer in which embedding vectors output from each artificial neural network are shared. And The dense layer 120 may be referred to as a fully connected layer (FC) due to the nature of the dense layer.

Specifically, the dense layer 120 means an embedding space in which embedding vectors output from each artificial neural network can be cross-learned or compared. Therefore, in determining the similarity between embedding vectors in the case of the present invention, in addition to simply comparing and analyzing embedding vectors having the same type of character (for example, vocal embedding and vocal embedding, drum embedding and drum embedding), embeddings with different types of characteristics can also be compared for mutual similarity.

That is, in providing a similar music search service through this method, the present invention not only searches for a similar sound source based on a sound source, but also searches for a similar sound source based on a stem. And similar stems can be searched, and similar stems can be searched based on the stem. Accordingly, the present invention can provide more diverse types of similar music search services.

Tagging information corresponding to each stem data of the plurality of embedding vectors that have passed through the dense layer 120 may be output.

Specifically, as shown in the drawing, the first embedding vector 21 output based on the first stem data 11 may be converted into first tagging information 31 and then output. The second embedding vector 22 output based on the second stem data 12 may be converted into second tagging information 32 and then output. The Nth embedding vector 29 output based on the Nth stem data 19 may be converted into Nth tagging information 39 and then output.

As described above, tagging information refers to information tagged with characteristics of music. Tagging means information that includes information about the genre, mood, instrument, and creation time of music.

For example, if the first artificial neural network 210 is an artificial neural network that outputs an embedding vector for a drum, the first tagging information 31 analyzes performance information about a drum included in the first stem data 11 and, information about what kind of musical characteristics the first stem data 11 has (information about whether the genre is rock, whether the mood is happy, etc.) can be output as output information.

Conversely, if the second artificial neural network 220 is an artificial neural network that outputs an embedding vector for vocals, the second tagging information 32 analyzes the drum performance information included in the second stem data 12 and, information about what kind of musical characteristics the second stem data 12 has (information about whether the genre is hard rock, whether the mood is sad, etc.) can be output as output information.

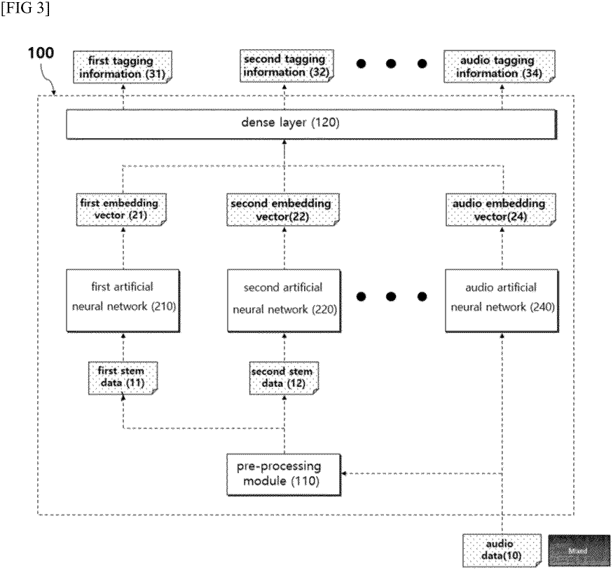

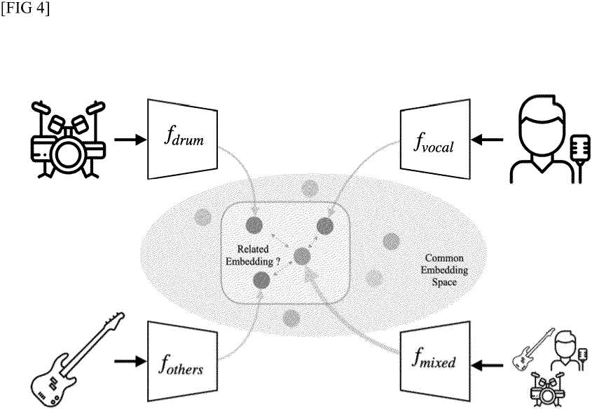

FIG. 3 is a diagram showing the configuration of a processor and input information and output information according to another embodiment of the present invention. FIG. 4 is a drawing for explaining a state in which various types of embedding vectors according to the present invention are compared and analyzed in one embedding space.

Referring to FIG. 3, the artificial neural network module 100 according to the present invention includes a preprocessing module 110, a first artificial neural network 210, a second artificial neural network 220, and an audio artificial neural network 240 and dense layer 120. For convenience of explanation below, the artificial neural network module 100 is illustrated as including two artificial neural networks 210 and 220 except for the audio artificial neural network 240, but as described above, the artificial neural network module 100 may include more n artificial neural networks than shown in the figure, depending on the type of input stem data.

On the other hand, the preprocessing module 110, the first artificial neural network 210, the second artificial neural network 220, and the dense layer 120 according to FIG. 3 correspond to the same components as those previously described in FIG. 2. Therefore, the description of this part will be omitted, and the audio artificial neural network 240, which is the difference, will be focused on.

The audio artificial neural network 240 according to the present invention refers to a pre-learned artificial neural network that receives audio data 10 as input information and outputs an audio embedding vector, which is an embedding vector for the audio data 10, as output information. That is, in the first artificial neural network 210 and the second artificial neural network 220, the stem data extracted from the audio data 10 in the preprocessing module 110 is input as the input information of the artificial neural network, but the difference exists in that the audio data 10 is directly input to the audio artificial neural network 240 without going through the pre-processing module 110.

Therefore, unlike the artificial neural network module 100 in FIG. 2, the artificial neural network module 100 according to FIG. 3 outputs the audio embedding vector 24 from the audio artificial neural network 240, so the dense layer 120 according to FIG. 3 can receive the audio embedding vector 24 as input information, and accordingly, the tagging information output through the dense layer 120 can include the audio tagging information 34.

As described in FIG. 2, the dense layer according to FIG. 3 means an embedding space in which embedding vectors output from each artificial neural network can be cross-learned or compared. Unlike FIG. 2, the audio embedding vector 24 output in the audio artificial neural network 230 is also output to the dense layer 120.

Therefore, in determining the similarity between embedding vectors in the case of the present invention, in addition to simply comparing and analyzing embedding vectors having the same type of character (for example, vocal embedding and vocal embedding, drum embedding and drum embedding), as shown in FIG. 4, the similarity between the audio embedding vector generated based on the audio data 10 and the embedding vectors generated based on the stem data can be compared.

That is, in the case of the present invention, by utilizing these characteristics, not only searches for similar sound sources based on sound sources, but also similar sound sources based on stems, similar stems based on similar sound sources, and similar stems based on stems. Therefore, there is an advantage of providing more diverse types of similar music search services.

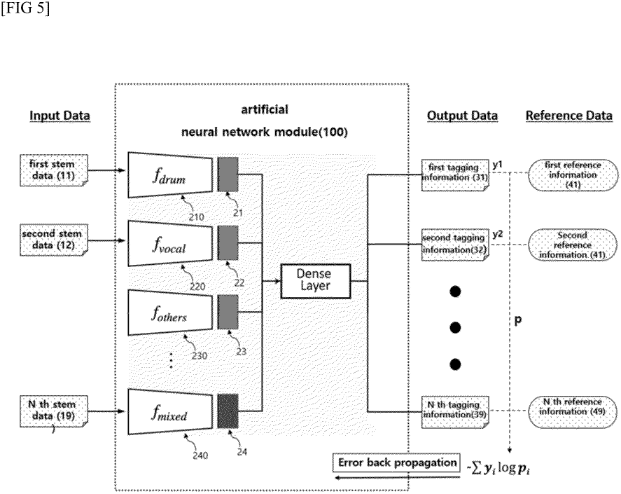

FIG. 5 is a diagram for explaining how an artificial neural network module learns according to an embodiment of the present invention.

Referring to FIG. 5, the artificial neural network module 100 according to the present invention may perform learning independently or integratedly in performing learning for each of the artificial neural networks 210, 220, 230, and 240.

The method of independently performing learning means adjusting parameters only for the artificial neural network in adjusting the parameters of the artificial neural network using reference data. Specifically, the first artificial neural network 210 takes the difference between the first tagging information 31 and the first reference data 41 output corresponding to the first embedding vector 21 as a loss function. And learning is performed in a direction of reducing the difference, and parameters of the first artificial neural network 210 may be adjusted based on this.

The second artificial neural network 220 also uses the difference between the second tagging information 32 and the second reference data 42 output corresponding to the second embedding vector 22 as a loss function, thereby learning may be performed in the direction of reducing the difference in the loss function, and based on this, parameters of the second artificial neural network 220 may be adjusted. The audio artificial neural network 240 may also perform learning in the same way.

In contrast, in the case of integrated learning, learning can be performed by not only adjusting the parameters of the artificial neural network based on reference data corresponding to a specific artificial neural network, but also adjusting the parameters of other artificial neural networks together.

Specifically, the first artificial neural network 210 takes the difference between the first tagging information 31 and the first reference data 41 output corresponding to the first embedding vector 21 as a loss function, learning can be performed in the direction of reducing the difference. Further, in adjusting parameters, learning may be performed by adjusting not only parameters of the first artificial neural network 210 but also parameters of other artificial neural networks related thereto.

The second artificial neural network 220 also uses the difference between the second tagging information 32 and the second reference data 42 output corresponding to the second embedding vector 22 as a loss function, learning can be performed in the direction of reducing the difference. Further, in adjusting parameters based on this, learning may be performed by adjusting not only parameters of the second artificial neural network 220 but also parameters of other artificial neural networks related thereto. The audio artificial neural network 240 may also perform learning in the same way.

This integrated learning method is possible because the dense layer 120 exists. When learning is performed integrally in one embedding space in this way, the characteristics of music can be shared with each other and, accordingly, the weights of parameters can be shared with each other, which has the advantage of increasing the accuracy and efficiency of learning of artificial neural networks. do.

That is, in the present invention, the learning accuracy increases since learning is performed while comparing and analyzing stem data for individual attributes among music attributes and audio data in which several attributes are mixed in a state in which weights are shared in the same space, and musical characteristics can be shared.

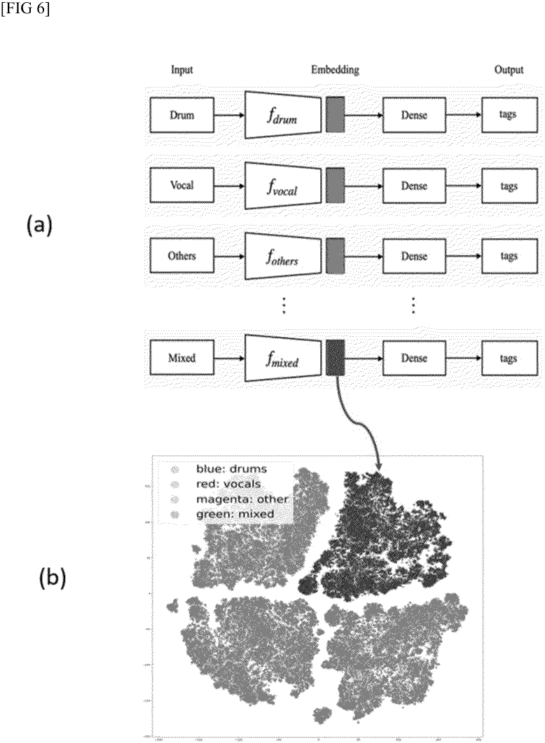

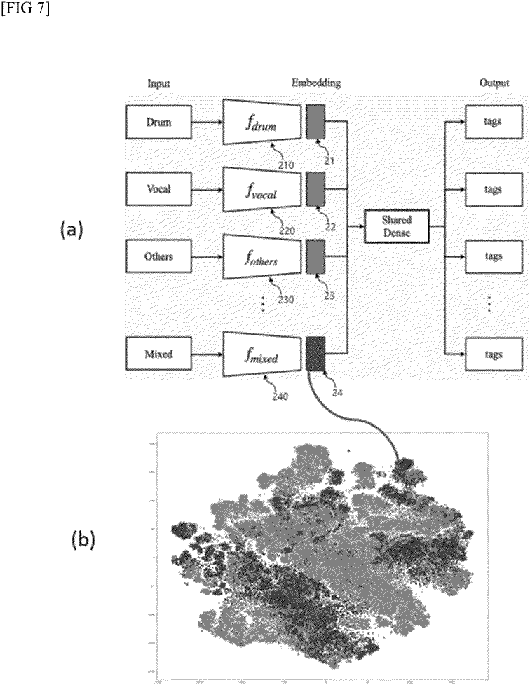

FIG. 6 is a diagram showing a learning method using an embedding vector according to the prior art. FIG. 7 is a diagram showing a learning method using an embedding vector according to the present invention.

Referring to FIG. 6, in the case of learning using embedding vectors according to the prior art, as shown in the figure, embedding vectors having the same characteristics among various properties of music are grouped. And it is distinct from embedding vectors those having different characteristics. Therefore, a comparative analysis is not performed on embedding vectors having different characteristics, which reduces the efficiency of learning.

However, in the case of the present invention, as shown in FIG. 7, not only embedding vectors having the same characteristics, but also embedding vectors having different characteristics can share characteristics. Therefore, the characteristics of the embedding vector of the audio data in which various attributes are mixed can be shared, and thus, there is an advantage in that efficiency and accuracy of learning are increased.

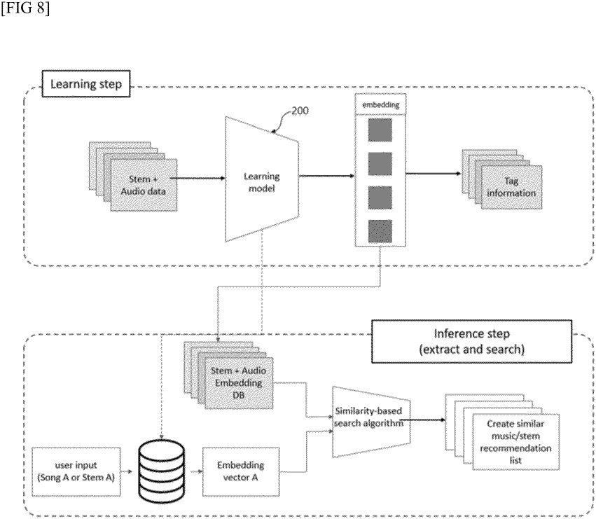

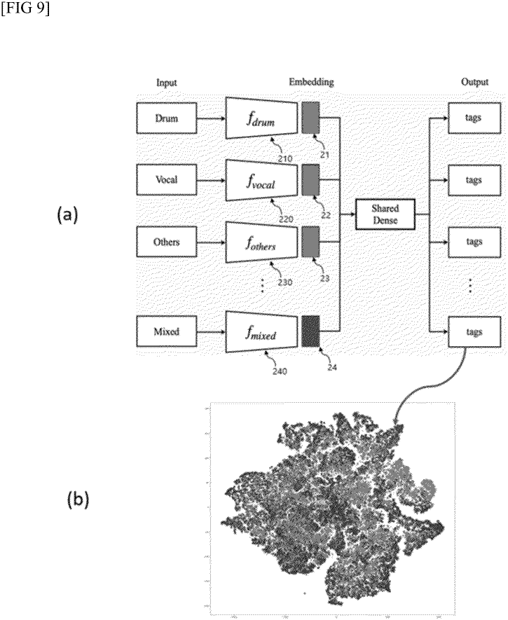

FIG. 8 is a diagram for explaining a learning step and an inference step of a music analysis device according to the present invention, the top diagram explains the learning step of an artificial neural network module, and the bottom diagrams for explaining the inference step of the artificial neural network module. FIG. 9 is a diagram showing the result of measuring similarity based on the tagging information output by the artificial neural network module according to the present invention.

Specifically, the learning step of FIG. 8 is the step described through the previous drawings, and when the audio data 10 and the stem data 11 to 13 that have passed through the preprocessing module 110 input to artificial neural network module 100 corresponding to the learning model, the embedding vectors 21 to 24 for the input data as intermediate output data and the tagging information 31 to 34 that have passed through the dense layer 120 are output as shown in the figure.

In the case of the inference step, it is a step of providing a similar music search service to the user. Specifically, the inference step can include an extraction step of extracting an embedding vector using the artificial neural network module 100 pre-learned for information (song or stem) input by the user, and a search step of searching for an embedding vector similar with the extracted embedding vector in the embedding vector database extracted in the learning step and generating a recommendation list for similar music or similar stems. The method for determining the similarity embedding vector applied in the inference step may be the same as the method used by the similarity calculation module 400 described above.

Meanwhile, in the drawing, the object to which the similarity-based search algorithm is applied is based on determining the similarity between embedding vectors, but the embodiment of the present invention is not limited thereto. Specifically, the similarity-based search algorithm can also create a stem list after outputting tagging information based on information input by a user, similar tagging information is searched in the tagging information database output by the artificial neural network module 100, and similar music or similar music or music is performed based on the searched result.

As shown in FIG. 9, when the tagging information output to each artificial neural network has similar characteristics, they can be grouped into the same group. Therefore, based on this information, a sound source or stem list having tagging information most similar with the sound source or stem input by the user can be created.

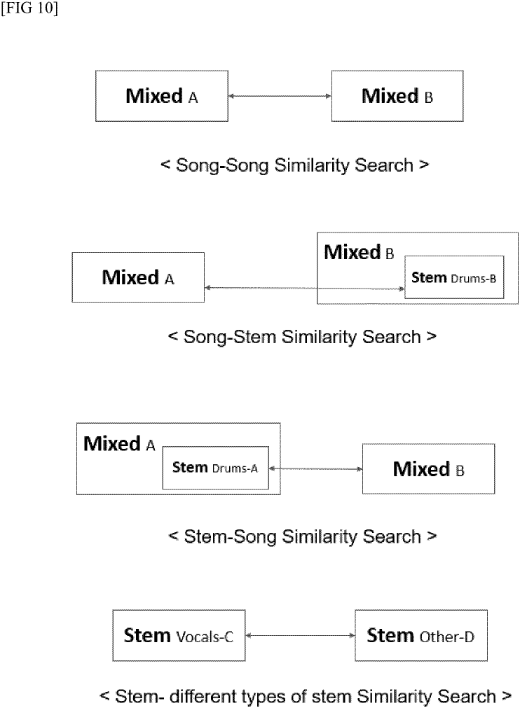

FIG. 10 is a diagram illustrating various embodiments of a music search service according to an embodiment of the present invention.

As described above, the music analysis device according to the present invention may recommend a similar sound source or a sound source having a similar stem based on input sound source data (mixed in the drawing) or stem data. That is, the music analysis device can search and recommend a sound source B having overall similar characteristics to the input sound source A as shown in the first diagram, and a vocal stem B having generally similar characteristics to the input sound source A as shown in the second diagram.

In addition, it is possible to search for and recommend a sound source B having generally similar characteristics to the input drum stem A as shown in the third diagram. And it can search and recommend an accompaniment stem D having generally similar characteristics to the input a vocal stem C as shown in the fourth diagram.

That is, in the case of the present invention, through this method, various types of sound sources or stems can be recommended beyond simple sound source recommendation, and thus there is an advantage of satisfying customer needs in various ways.

So far, the configuration and process of the music analysis method and apparatus according to the present invention have been studied in detail.

According to an embodiment, a music analysis method and apparatus for cross-comparing music properties using an artificial neural network combine an embedding vector for a sound source itself and an embedding vector generated based on data obtained by separating music properties from a sound source into one space. By performing cross-comparison analysis in, it is possible to perform comparative analysis between an embedding vector for audio data corresponding to a sound source and an embedding vector generated based on data obtained by separating only specific attributes from all audio data in one space. Therefore, since various characteristics of the embedding vector can be reflected, there is an advantage in that tagging information that more accurately reflects the characteristics of music can be output.

Accordingly, the music analysis method and apparatus according to the present invention provides a singer identification service based on the generated embedding vector and tagging information. Various services such as similar music services can be provided, and there is also an advantage in that the accuracy of the service can also be increased.

The devices described above may be implemented as hardware components, software components, and/or a combination of hardware components and software components. For example, devices and components described in the embodiments may include, for example, a processor, a controller, an arithmetic logic unit (ALU), a digital signal processor, a microcomputer, a field programmable array (FPA), It may be implemented using one or more general purpose or special purpose computers, such as a programmable logic unit (PLU), microprocessor, or any other device capable of executing and responding to instructions. The processing device may run an operating system (OS) and one or more software applications running on the operating system.

The method according to the embodiment may be implemented in the form of program instructions that can be executed through various computer means and recorded on a computer readable medium. The computer readable medium may include program instructions, data files, data structures, etc. alone or in combination. Program commands recorded on the medium may be specially designed and configured for the embodiment or may be known and usable to those skilled in computer software. Examples of computer-readable recording media include magnetic media such as hard disks, floppy disks and magnetic tapes, optical media such as CD-ROMs and DVDs, and magnetic media such as floptical disks. - includes hardware devices specially configured to store and execute program instructions, such as magneto-optical media, and ROM, RAM, flash memory, and the like. Examples of program instructions include high-level language codes that can be executed by a computer using an interpreter, as well as machine language codes such as those produced by a compiler.

As described above, although the embodiments have been described with limited examples and drawings, those skilled in the art can make various modifications and variations from the above description. For example, the described techniques may be performed in an order different from the method described, and/or components of the described system, structure, device, circuit, etc. may be combined or combined in a different form than the method described, or other components may be used. Or even if it is replaced or substituted by equivalents, appropriate results can be achieved. Therefore, other implementations, other embodiments, and equivalents of the claims are within the scope of the following claims.

### EXPLANATION OF NUMBER

100: music analysis device
200: processor
210: first artificial neural network
220: second artificial neural network
230: third artificial neural network
240: audio artificial neural network
300: memory module50
400: similarity calculation module
500: service providing module

1. A music analysis device that cross-compares music properties using an artificial neural network comprising:
a processor including an artificial neural network module and a memory module storing instructions executable by the processor;
the artificial neural network module including:
a pre-processing module that outputs stem data that is specific attribute data constituting the audio data according to a preset standard for the input audio data;
a first artificial neural network that takes first stem data as first input information and outputs a first embedding vector that is an embedding vector for the first stem data as first output information;
a second artificial neural network that takes second stem data as second input information and outputs a second embedding vector that is an embedding vector for the second stem data as second output information; and
a dense layer that uses information the first output information and the second output information are used as input information and output a first tagging information and a second tagging information as output information which are music tagging information for the first output information and the second output information.

2. The music analysis device according to claim 1,
wherein the attribute includes at least one of vocal, drum, bass, piano, and accompaniment data.

3. The music analysis device according to claim 1,
wherein the music tagging information includes at least one of genre information, mood information, instrument information, and creation time information of the music.

4. The music analysis device according to claim 3,
wherein the artificial neural network module performs learning on the first artificial neural network and the second artificial neural network based on the first output information, the second output information, the first tagging information, the second tagging information, first reference data corresponding to the first tagging information, and the second reference data corresponding to the second tagging information.

5. The music analysis device according to claim 4,
wherein the artificial neural network module performs learning by adjusting parameters of the first artificial neural network and the second artificial neural network based on a difference between the first tagging information and the first reference data, and
performs learning by adjusting parameters of the first artificial neural network and the second artificial neural network based on a difference between the second tagging information and the second reference data.

6. The music analysis device according to claim 4,
wherein the artificial neural network module further includes a mixed artificial neural network that takes the audio data as input information and outputs a mix embedding vector, which is an embedding vector for the audio data, as mix output information,
wherein the dense layer takes the mix output information as input information and outputs mix tagging information that is music tagging information for the mix output information as output information,
wherein the artificial neural network module performs learning on the first artificial neural network, the second artificial neural network, and the mixed artificial neural network based on the first output information, the second output information, the mixed output information, the first tagging information, the second tagging information, the mix tagging information, the first reference data, the second reference data, and mix reference data corresponding to the mix tagging information.

7. A music analysis method for cross-comparison of music properties using artificial neural networks comprising:
a pre-processing step for outputting stem data, which is specific attribute data constituting the audio data, according to a standard set-in advance for an input audio data;
a first output information output step for outputting a first embedding vector by using a first artificial neural network that takes first stem data as first input information and outputs the first embedding vector, which is an embedding vector for the first stem data, as first output information;
a second output information output step for outputting a second embedding vector by using a second artificial neural network that takes second stem data as second input information and outputs the second embedding vector, which is an embedding vector for the second stem data, as second output information; and
a tagging information output step for taking the first output information and the second output information as input information and outputting a first tagging information and second tagging information which are music tagging information for the first output information and the second output information.

8. An apparatus for providing a similar music search service based on music properties using an artificial neural network comprising:
a memory module storing an audio embedding vector of audio data and a stem embedding vector corresponding to stem data of the audio data;
a similarity calculation module calculating a similarity between at least one of the audio embedding vector and the stem embedding vector and an input audio embedding vector that is an embedding vector for input audio data input by a user; and
a service providing module providing a music service to the user based on a result calculated by the similarity calculation module;
wherein the stem data is data for a specific attribute constituting the audio data according to a preset criterion.

9. The apparatus according to claim 8,
wherein the memory module stores audio tagging information and stem tagging information corresponding to the audio embedding vector and the stem embedding vector, respectively; and
wherein the similarity calculating module calculates a similarity between at least one of the audio tagging information and the stem tagging information and input audio tagging information corresponding to the input audio embedding vector.
